(19) United States
(12) Patent Application Publication
(10) Pub. No.: US 2005/0225043 A1
(43) Pub. Date: Oct. 13, 2005

(54) Fuelling device for a motor vehicle and method of making same

(75) Inventors: Andreas Dehn, Tuebingen (DE); Ferdinand Gaiser, Simmozheim (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/060,376

(22) Filed: Feb. 17, 2005

(30) Foreign Application Priority Data
Feb. 18, 2004 (DE) 10 2004 007 783.5

(51) Int. Cl. B60G 1/00

(52) U.S. Cl. 280/29

(57) ABSTRACT

A fuelling device for a motor vehicle has a tank filler neck being surrounded at least in areas by a foam material. For improving safety particularly in the event of a rear impact, the foam material is constructed as an essentially nondeformable matrix.

### BACKGROUND AND SUMMARY OF THE INVENTION

This application claims the priority of German Application No.: 10 2004 007 783.5-25 filed on Feb. 8, 2004, the disclosure of which is expressly incorporated by reference herein.

The invention relates to a fuelling device for a motor vehicle and method of making same. Certain preferred embodiments relate to a fuelling device for a motor vehicle having a tank filler neck, the tank filler neck being surrounded at least in areas by a foam material.

In the event of a rear impact on motor vehicles, there is the danger that the fuelling device, particularly the tank filler neck, is damaged and fuel or fuel vapors therefore reach the open air. A problem is caused, for example, by an activated-carbon filter normally arranged in the wheel house for adsorbing fuel vapors from the tank, which, in the event of an intrusion at the rear, can be pushed against the fuelling pipes of the filler neck. Because of the limited availability of space, however, a different positioning of the activated-carbon filter is difficult.

For increasing crash safety, it is suggested in German Published Patent Application DE 100 28 855A1that a filler neck section be surrounded by an energy-absorbing foam coating.

It is an object of the invention to provide a fuelling device with an improved protection of the tank filler neck against damage, particularly in the event of a rear impact.

This object is achieved according to certain preferred embodiments of the invention, by providing a fuelling device for a motor vehicle having a tank filler neck, the tank filler neck being surrounded at least in areas by a foam material, wherein the foam material is constructed as an essentially nondeformable matrix. Favorable further developments and advantages of the preferred embodiments of invention are described herein and in the claims.

In the case of a fuelling device for a motor vehicle according to the invention, a filler pipe section is provided at least in areas with a foam material which is constructed as an essentially nondeformable matrix. The foam material has a relative density of such a sufficient amount that the foam material remains rigid under an effect of impact energy, so that pipes and pipe connections embedded therein cannot be pushed against one another. As a function of the required stiffness of the arrangement, coordination can take place in that a corresponding density of the foam material or a corresponding material is selected. The filigree and slender tank filler neck thereby acts as a stiff unit, so that all vulnerable pipes and components connected thereto, such as the filling and vent pipes, the valves and expansion tanks are securely embedded in the stiff foam material in the possible impinging area of impact energy. The tank filler neck with its pipes and pipe connections can only still be displaced as a whole with the foam material. If, for example, in the event of a rear impact, an activated-charcoal filter is pressed against this entity, this filter is supported by way of the foam material and not on the pipes. In this case, damage particularly of the small vent pipes can largely be avoided. The foam material can be inserted independently of the pipe material values and pipe geometries and causes only little additional weight. Furthermore, the foam material can be combined with other protective measures of the fuelling device.

If, in the vehicle-side area, at least the tank filler neck and an adjoining area of its filling pipe section is surrounded with foam material according to certain preferred embodiments of the invention, a tearing-off of pipes and/or holding devices in this area can be securely and reliably avoided. Pipes are protected from major loads. Also pipes with only a slight ductile yield, such as plastic pipes, can therefore be easily and securely protected. The foam material is preferably constructed as a compact block which also fills hollow spaces between the tank filler neck and pipes and the like. Optionally, the foam material can also be arranged in a frame-type or honeycomb-type manner for optimizing the weight, in which case the pipes, the pipe connections and the like are embedded in the foam material. However, hollow spaces may be arranged between such components surrounded by foam material. The person skilled in the art will select a configuration here which appears appropriate to him. The total area having foam material is selected such that it comprises a probable impinging area of impact energy, particularly in the event of a rear impact.

The area having the foam material preferably comprises one or more pipe connections to the tank filler neck and/or to the filling pipe section according to certain preferred embodiments of the invention. As a result, all critical points of the fuelling device can be included. The foam material can be applied in a simple manner and can be adapted to arbitrary geometries in that the area to be protected is correspondingly filled. The almost rigid behavior of the foam material as a nondeformable matrix around the pipes and pipe connections causes a support of a load acting from the outside only by way of the hard foam material. A sufficient dimensioning of the matrix stiffness and a correspondingly large-surface load distribution can be achieved by means of simple devices.

A favorable material for the foam material contains polyurethane according to certain preferred embodiments of the invention. Optionally, EPP can also be selected as the foam material. Irrespective of the material, the foam material preferably has a relative density of at least 80 grams/liter, particularly preferably a relative density of at least 200 grams/liter. Polyurethane with a relative density of at least 300 grams/liter is particularly advantageous.

If the foam material is applied such that pipe connections embedded therein and/or pipes embedded therein remain in a rigid spatial assignment with respect to one another, it can be ensured by the “freezing” of the pipes that embedded pipes experience no relative displacements with respect to one another. Elongations of the pipes are avoided so that also materials with a slight ductile yield are reliably protected by the embedding in the foam material.

It is particularly advantageous that the foam material can be subsequently placed in already existing fuelling devices and also in addition to further protective measures according to certain preferred embodiments of the invention.

In the following, the invention will be explained in detail by means of an embodiment illustrated in the drawing. The drawing, the description and the claims contain numerous combined characteristics which the person skilled in the art will expediently also consider individually and combine to appropriate additional combinations.

Other objects, advantages and novel features of the present invention will become apparent from the following detailed description of the invention when considered in conjunction with the accompanying drawings.

### BRIEF DESCRIPTION OF THE DRAWINGS

FIG. 1 is an overview of a vehicle rear at the case of a rear impact; and

FIG. 2 is a schematic view of a fuelling device with an outlined foam area according to the invention.

### DETAILED DESCRIPTION OF THE DRAWINGS

In the drawings, identical parts always have the same reference numbers.

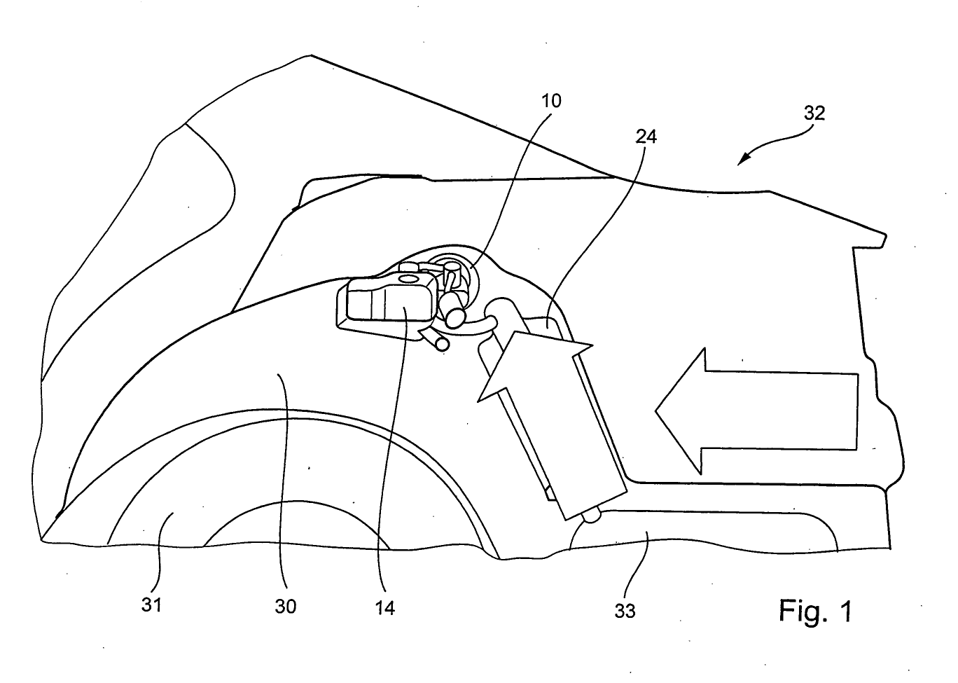

FIG. 1 is an overview of an effect of a force onto a rear 32 of a vehicle not described in detail in the case of a rear impact. A fuelling device with a tank filler neck 10 is arranged adjacent to a wheel house 30. As an example and without further details, the tank filler neck 10 and an expansion tank 14 of the fuelling device are illustrated, which extend into the wheel house 30. In the wheel house 30, an activated-carbon filter 24 is arranged which stores the fuel vapors from a tank 33 which is filled by way of the tank filler neck 10. In the event of a rear impact, the body shell pushes the activated-carbon filter 24 upward against the tank filler neck 10, as indicated by the horizontal arrow and the arrow pointing diagonally upward. In this case, the tank filler neck 10 and pipes not illustrated in detail are pressed against the stiff flange of the wheel housing and may be damaged.

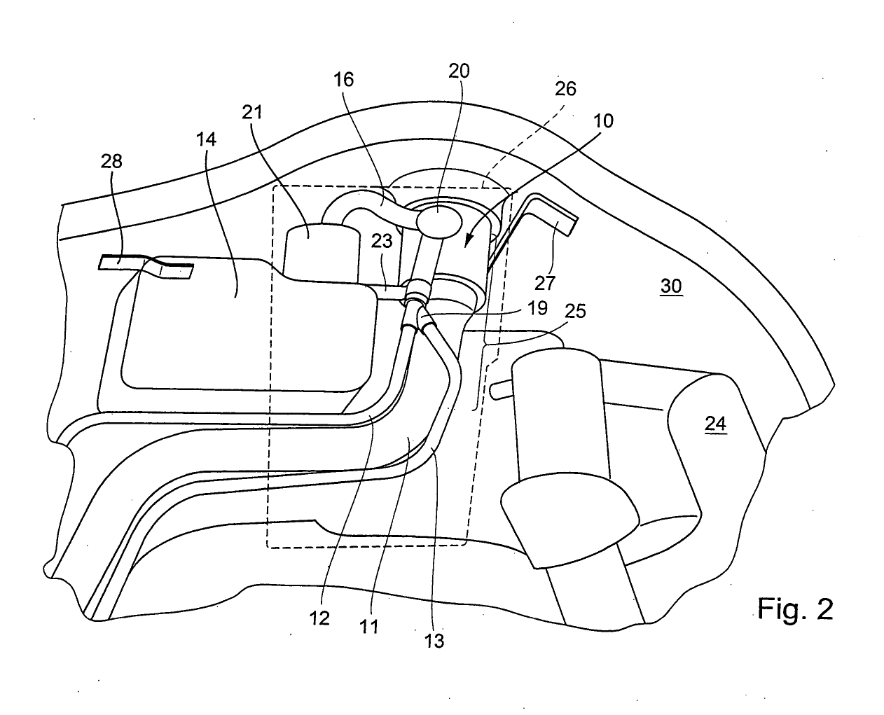

FIG. 2 illustrates an arrangement according to the invention. An area 26, which is highlighted by a broken bordering, is filled with a foam material. In the vehicle-side area, at least the tank filler neck 10 and its adjoining filling pipe section 25 are surrounded by the foam material. For the purpose of clarity, the foam material is not entered.

The area 26 having the foam material comprises one or more pipe connections 18, 19, 20 to the tank filler neck 10 and/or its filing pipe section 25, as well as a holding device 23 between the tank filler neck 10 and an expansion tank 14. A holding device 27, by means of which the tank filler neck 10 is fastened to the vehicle body, is at least partially embedded in the foam material. Likewise, the expansion tank 14 is partially embedded in the foam material with its side close to the tank filler neck. Naturally, pipes, pipe connections and holding devices at the expansion take can also be embedded in the foam material according to certain preferred embodiments of the invention. The foam material preferably is polyurethane having a relative density of at least 200 grams/liter. Pipe connections 18, 19, 20, 21 embedded in the foam material and/or pipes 11, 12, 13, 16 and/or holding devices embedded in the foam material will remain in a rigid spatial arrangement with respect to one another where the foam material is applied. The embedded components are also fixed with respect to a mutual displacement under the effect of impact energy.

Much damage, which could arise at the fuelling device in the event of a rear impact, can be avoided according to the invention. The pipes 11, 12, 13, 16 and pipe connections 18, 19, 20 as well as the holding device 23 arranged at the tank filler neck 10 or its filling pipe section 25 are protected by the rigid foam material in area 26 and cannot be displaced with respect to one another. Likewise, the pipe 16 between the tank filler neck 10 and the expansion tank 14 can also not tear off; the holding device 23 between the tank filler neck 10 and the expansion tank 14 remains undamaged and is not torn out of the expansion tank 14.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. Fuelling device for a motor vehicle having a tank filler neck, the tank filler neck being surrounded at least in areas by a foam material,
wherein the foam material is constructed as an essentially nondeformable matrix.

2. Fuelling device according to claim 1, wherein, in a vehicle-side area, at least the tank filler neck and an area of its filling pipe section adjoining the tank filler neck are surrounded by the foam material.

3. Fuelling device according to claim 1, wherein the area having the foam material comprises one or more pipe connections to the tank filler neck and/or the filling pipe section.

4. Fuelling device according to claim 2, wherein the area having the foam material comprises one or more pipe connections to the tank filler neck and/or the filling pipe section.

5. Fuelling device according to claim 1, wherein the foam material contains a polyurethane material.

6. Fuelling device according to claim 2, wherein the foam material contains a polyurethane material.

7. Fuelling device according to claim 3, wherein the foam material contains a polyurethane material.

8. Fuelling device according to claim 1, wherein the foam material has a relative density of at least 80 grams/liter.

9. Fuelling device according to claim 2, wherein the foam material has a relative density of at least 80 grams/liter.

10. Fuelling device according to claim 4, wherein the foam material has a relative density of at least 80 grams/liter.

11. Fuelling device according to claim 1, wherein the foam material has a relative density of at least 200 grams/liter.

12. Fuelling device according to claim 2, wherein the foam material has a relative density of at least 200 grams/liter.

13. Fuelling device according to claim 4, wherein the foam material has a relative density of at least 200 grams/liter.

14. Fuelling device according to claim 1, wherein the foam material is applied such that pipe connections embedded therein and/or pipes embedded therein remain in a rigid spatial assignment to one another.

15. Fuelling device according to claim 4, wherein the foam material is applied such that pipe connections embedded therein and/or pipes embedded therein remain in a rigid spatial assignment to one another.

16. Fuelling device according to claim 11, wherein the foam material is applied such that pipe connections embedded therein and/or pipes embedded therein remain in a rigid spatial assignment to one another.

17. A method of making a vehicle assembly including a tank filler neck, comprising surround the tank filler neck in areas by foam material constructed as an essentially nondeformable matrix.

18. A method of making a vehicle assembly according to claim 17, wherein, in a vehicle-side area, at least the tank filler neck and an area of its filling pipe section adjoining the tank filler neck are surrounded by the foam material.

19. A method of making a vehicle assembly according to claim 18, wherein the area having the foam material comprises one or more pipe connections to the tank filler neck and/or the filling pipe section.

20. A method of making a vehicle assembly according to claim 19, wherein the foam material has a relative density of at least 80 grams/liter.

21. A method of making a vehicle assembly according to claim 19, wherein the foam material has a relative density of at least 200 grams/liter.

22. A method of making a vehicle assembly according to claim 21, wherein the foam material is applied such that pipe connections embedded therein and/or pipes embedded therein remain in a rigid spatial assignment to one another.
